(19) United States
(12) Patent Application Publication
(10) Pub. No.: US 2026/0348638 A1
(43) Pub. Date: Nov. 5, 2026

(54) REFRIGERATOR

(71) Applicant: LG ELECTRONICS INC., Seoul (KR)

(72) Inventors: Donghoon LEE, Seoul (KR); Donghoon LEE, Seoul (KR); Sunggyun SON, Seoul (KR); Wookyong LEE, Seoul (KR)

(21) Appl. No.: 19/119,880

(22) PCT Filed: Sep. 7, 2023
(86) PCT No.: PCT/KR2023/013403

§ 371 Date: Apr. 10, 2025

(30) Foreign Application Priority Data
Oct. 13, 2022 (KR) 10-2022-0131546

(51) Int. Cl. F25C 5/20; B67D 3/00; F25D 23/02; F25D 29/00

(52) U.S. Cl. CPC F25C 5/22; B67D 3/0025; F25D 23/028; F25D 29/005; B67D 2210/00036; F25C 2400/04

(57) ABSTRACT

A refrigerator of an embodiment includes: a cabinet forming a storage room; a door for opening or closing the storage room; an ice maker which is provided in the cabinet or the door and generates ice; and a dispenser which is provided on the door and dispenses ice generated by the ice maker, wherein the dispenser includes: a dispenser housing; a recessed accommodation part provided in the dispenser housing; a manipulating member movably installed in the dispenser housing; a switch installed in the accommodation part; and a lever for transmitting a manipulation force of the manipulating member to the switch, and the manipulating member includes a hinge and a lever manipulation part which is positioned lower than the hinge and manipulates the lever.

### TECHNICAL FIELD

The present disclosure relates to a refrigerator.

### BACKGROUND ART

In general, a refrigerator is a home appliance for storing food at a low temperature in a storage space that is covered by a door.

The refrigerator is configured to keep stored food in in a refrigerated state or frozen state by cooling an inside of the storage space using cold air.

The refrigerator may be a side-by-side type refrigerator in which a freezing chamber and a refrigerating chamber are arranged left and right, a top mount type refrigerator in which the freezing chamber is located above the refrigerating chamber, or a bottom freezer type refrigerator in which the refrigerating chamber is located above the freezing chamber.

Typically, an ice maker is provided in the freezing chamber of a refrigerator to make ice. The ice maker receives water supplied from a water source or a water tank in a tray and cools the water to generate ice. The ice generated by the ice maker may be stored in an ice bin.

The ice stored in the ice bin can be discharged through a dispenser provided in the door, or the user can open a freezing chamber door, approach the ice bin, and take out the ice in the ice bin.

A refrigerator is disclosed in Korean Patent Publication No. 10-2016-0136659 that is a prior art document.

The refrigerator of the prior art document comprises a cabinet in which a refrigerating chamber and a freezing chamber below the refrigerating chamber are formed; a pair of refrigerating chamber doors arranged on the left and right sides to open and close the refrigerating chamber, and an ice maker and a dispenser being provided on one side; a main water tank provided in the refrigerating chamber and cooling the supplied water; a water purifier provided in the cabinet and purifying supplied water; a sub water tank provided in the refrigerating chamber door and additionally cooling the supplied water; a water supply path connecting the water purifier, the main water tank, the sub water tank, the dispenser and the ice maker; and a branch valve provided on the water supply path of the refrigerating chamber door to selectively supply purified water to the dispenser or the ice maker.

However, in the case of the prior document, since the sub-water tank and the branch valve are provided at a rear of the dispenser, there is a disadvantage that a space at the rear of the dispenser cannot be used as a separate storage space or an ice making chamber.

Even in the case of the prior document, if an additional space is formed at the rear of the dispenser, a thickness of the door becomes thicker, so there is a disadvantage that a volume of the refrigerating chamber decreases by the thickness of the thickened door.

### DISCLOSURE

### Technical Problem

One embodiment provides a refrigerator having a slim dispenser.

Alternatively or additionally, one embodiment provides a refrigerator that can form a space for a specific use at a rear of the dispenser.

Alternatively or additionally, one embodiment provides a refrigerator that reduces a space occupied by a pad and a space for pad operation.

Alternatively or additionally, one embodiment provides a refrigerator that allows a user to easily manipulate a pad.

### Technical Solution

In one embodiment, a refrigerator may include a cabinet. The cabinet may have a storage space. The refrigerator may further include a door for opening and closing the storage space. The refrigerator may further include an ice maker. The ice maker may be provided in the cabinet or the door. The refrigerator may further include a dispenser provided in the door and for discharging ice generated by the ice maker.

The dispenser may include a dispenser housing. The dispenser may further include a receiving portion having a recessed shape and provided in the dispenser housing. The dispenser may further include a pad (or operation portion) movably installed in the dispenser housing. The dispenser may further include a switch installed in the receiving portion.

The dispenser may further include a lever for transmitting an operating force of the pad to the switch. The pad may include a hinge that allows the pad to rotate. The pad may include a lever operating portion for operating the lever and disposed at a lower side of the hinge.

The receiving portion may include a hinge supporter that rotatably supports the hinge. The switch may be disposed at a lower side of the hinge supporter.

The dispenser may further include an elastic member that elastically supports the pad. The receiving portion may further include a first supporter that supports the elastic member.

The receiving portion may include a first wall on which the switch is installed. The receiving portion may further include a second wall that is stepped from the first wall.

The hinge supporter may be provided on the first wall. The first supporter may be provided on the second wall.

A horizontal distance from the first wall to a center of the hinge may be greater than a horizontal distance from the first wall to a surface of the switch facing the pad.

The second wall may be disposed closer to an opening of the dispenser housing than the first wall.

The pad may further include a second supporter that supports the elastic member and is disposed lower than the lever operating portion.

The first supporter may include a seating groove on which the elastic member is seated.

In a non-operated state of the pad, the second supporter may be disposed outside the seating groove. In an operated state of the pad, a portion of the second supporter may be received within the seating groove.

The receiving portion may include a first wall in which the switch is installed.

The receiving portion may further include a second wall that is stepped from the first wall and in which the hinge supporter is formed.

The first wall may be disposed closer to an opening of the dispenser housing than the second wall.

In a non-operated state of the pad, a horizontal distance from the second wall to a rotation center of the hinge may be equal to or less than a horizontal distance from the rotation center to a front uppermost portion of the pad.

In a non-operated state of the pad, a distance from the switch to a rear surface of the pad may be less than a distance from the first wall to a surface of the switch facing the pad.

A distance from a vertical line extending vertically from a front bottom end of the pad to a point on a front surface of the pad may be equal to or greater than a distance from the switch to a point on a rear surface of the pad. The point on the front surface is a point facing the switch, and the point on the rear surface is a point disposed at the same height as the point on the front surface.

The receiving portion may further include a third wall that is stepped from the first wall and in which the first supporter is formed. The third wall may be disposed closer to an opening of the dispenser housing than the first wall. A size of a step difference between the first wall and the second wall may be greater than a size of a step difference between the first wall and the third wall.

The receiving portion may further include a lever shaft rotatably supporting the lever. The lever may include a lever body coupled to the lever shaft. The lever may further include a first extension extending from one point of the lever body and pressed by the pad. The lever may further include a second extension extending from another point of the lever body and transmitting a rotational force of the lever to the switch.

In another embodiment, a refrigerator may include a dispenser. The dispenser may include a dispenser housing.

The dispenser may further include a receiving portion having a recessed shape and provided in the dispenser housing. The dispenser may further include a pad (or operation portion) movably installed in the dispenser housing.

The dispenser may further include a switch installed in the receiving portion. The dispenser may further include a lever for transmitting an operating force of the pad to the switch.

The pad may include a hinge. The pad may further include a lever operating portion disposed at an upper side of the hinge for operating the lever. The pad may further include a supporter disposed higher than the lever operating portion for supporting the elastic member.

The receiving portion may include a plurality of coupling protrusions for coupling with the switch. The receiving portion may further include a hook that is caught on the switch in a state in which the plurality of coupling protrusions are inserted into the switch.

The receiving portion may include a first portion in which the hinge is installed. The receiving portion may further include a second portion disposed at an upper side of the first portion and having a different recessed depth from the first portion. The receiving portion may further include a third portion disposed at an upper side of the second portion and in which the switch is installed. At least a portion of the second portion may be disposed closer to an opening of the dispenser housing than the first portion and the third portion.

### Advantageous Effects

According to one embodiment, a dispenser is slim, which has an advantage of forming a space for a specific purpose at a rear side of the dispenser.

According to one embodiment, a space occupied by a pad and a space for pad operation are reduced.

According to one embodiment, since a hinge is located at an upper side of a pad, the pad can be operated by pressing a portion of the pad disposed lower than the hinge, which has an advantage of allowing the user to easily operate the pad.

### DESCRIPTION OF DRAWINGS

FIG. 1 (a) is a front view of a refrigerator according to a first present embodiment, and (b) is a drawing showing a state in which one door of the refrigerator is separated.

FIG. 2 (a) is a perspective view of a first refrigerating chamber door as viewed from a front side according to a first embodiment, (b) is a perspective view of a first refrigerating chamber door as viewed from a rear side according to a first embodiment, and (c) is a lateral side view of a first refrigerating chamber door according to a first present embodiment.

FIG. 3 is a cross-sectional view taken along line 3-3 of FIG. 1A.

FIG. 4 is a drawing showing cold air passage in a first refrigerating chamber door of a first embodiment.

FIG. 5 is an exploded perspective view of a dispenser according to a first present embodiment.

FIG. 6 is a drawing showing a state in which a pad, a switch, and a lever are separated in a dispenser according to a first embodiment.

FIG. 7 is a drawing showing a receiving portion according to a first embodiment.

FIG. 8 is a vertical cross-sectional view showing a state in which a pad is installed in a dispenser according to a first embodiment.

FIG. 9 is a cross-sectional view showing a structure of a first supporter according to a first embodiment.

FIG. 10 is a vertical cross-sectional view showing a state in which a pad is installed in a dispenser according to a second embodiment.

FIG. 11 is a cross-sectional view showing a structure of a first supporter according to a second embodiment.

FIG. 12 is a drawing showing a state in which a pad, a switch, and a lever are separated in a dispenser according to a third embodiment.

FIG. 13 is a drawing showing a state in which a switch and a lever are installed in a receiving portion according to a third embodiment.

FIG. 14 is a vertical cross-sectional view showing a state in which a pad is installed in a dispenser according to a third embodiment.

### MODE FOR INVENTION

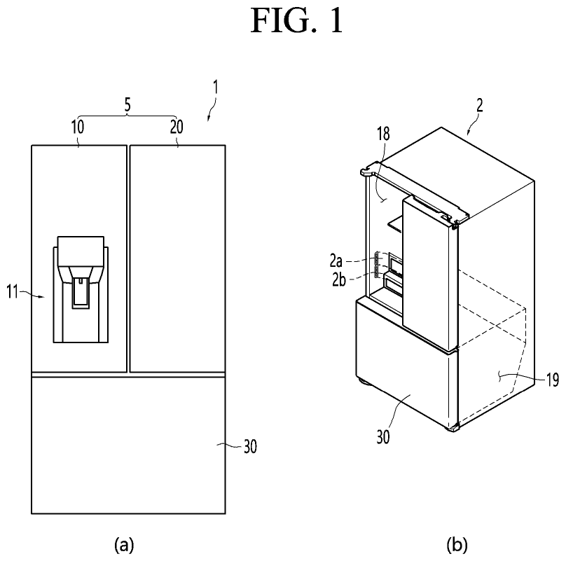

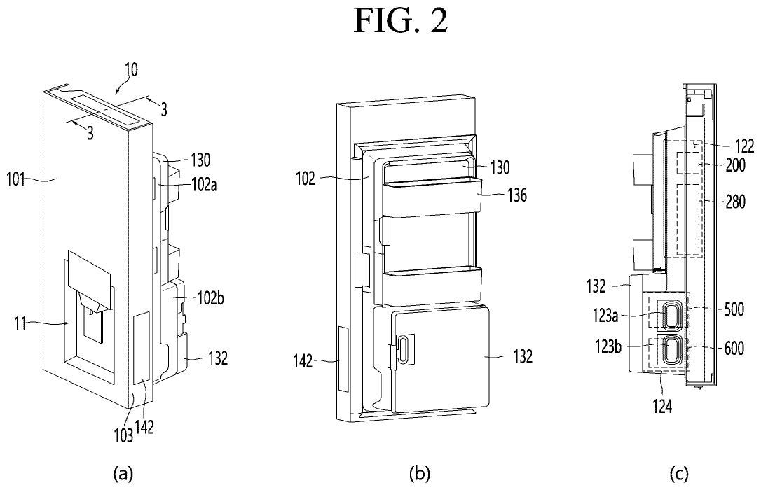

FIG. 1a is a front view of a refrigerator according to a first present embodiment. FIG. 1b is a drawing showing a state in which one door of the refrigerator is separated. FIG. 2a is a perspective view of a first refrigerating chamber door as viewed from a front side according to a first embodiment. FIG. 2b is a perspective view of a first refrigerating chamber door as viewed from a rear side according to a first embodiment. FIG. 2c is a lateral side view of a first refrigerating chamber door according to a first present embodiment.

Referring to FIGS. 1 to 2, a refrigerator 1 of the present embodiment may include a cabinet 2 having a storage space. The refrigerator 1 may further include a refrigerator door configured to open and close the storage space.

The storage space may include a refrigerating chamber 18. The storage space may optionally or additionally include a freezing chamber 19. As an example, FIG. 2 illustrates that the storage space includes a refrigerating chamber 18 and a freezing chamber 19.

The refrigerating chamber 18 may be opened and closed by one or more refrigerating chamber doors 5. The freezing chamber 19 may be opened and closed by one or more freezing chamber doors 30.

Hereinafter, the refrigerating chamber 18 is described as being opened and closed by a first refrigerating chamber door 10 and a second refrigerating chamber door 20.

At least one of the first refrigerating chamber door 10 or the second refrigerating chamber door 20 may include a dispenser 11 for discharging water and/or ice. Of course, depending on a type of refrigerator, it is also possible for the freezing chamber door 30 to be provided with the dispenser 11.

At least one of the first refrigerating chamber door 10 or the second refrigerating chamber door 20 may include at least one ice maker.

Hereinafter, an example of an ice maker being provided in the first refrigerating chamber door 10 will be described. Of course, if necessary, an ice maker may also be provided in the second refrigerating chamber door 20 or the freezing chamber door 30. At this time, the dispenser 11 and the ice maker may be provided in the same door.

Hereinafter, an example will be described in which the first refrigerating chamber door 10 includes a plurality of ice makers. It is not limited thereto, and the second refrigerating chamber door 20 may also include a plurality of ice makers.

In FIG. 1, the refrigerator 1 is exemplarily illustrated as a bottom freezer type refrigerator, but it is to be noted that an idea of the present invention can be equally applied to a side-by-side type refrigerator or a top-mount type refrigerator. In the case of a side-by-side type or top-mount type refrigerator, the freezing chamber door may include a plurality of ice makers or the refrigerating chamber door may include a plurality of ice makers.

The dispenser 11 is disposed at a front side of the first refrigerating chamber door 10, and a portion of the dispensers may be recessed toward rearward to provide a space where a container can be disposed.

The plurality of ice makers may be arranged in a vertical direction. For example, the plurality of ice makers may include a first ice maker 200. The plurality of ice makers may further include a second ice maker 500. The second ice maker 500 may be disposed at a lower side of the first ice maker 200. Of course, the present embodiment does not exclude the plurality of ice makers 200, 500 being arranged in a left-right direction.

The dispenser 11 may discharge at least ice generated in the first ice maker 200. To this end, the first ice maker 200 may positioned higher than the dispenser 11.

If the dispenser 11 may discharge ice generated in the second ice maker 500, the second ice maker 500 may also positioned higher than the dispenser 11. Or, even if at least the second ice maker 500 is positioned the same as or lower than the dispenser 11, ice generated in the second ice maker 500 can be transferred to the dispenser 11 by a separate transfer mechanism. As another example, the dispenser 11 may include a first dispenser to discharge ice generated in the first ice maker 200, and a second dispenser to discharge ice generated in the second ice maker.

The second ice maker 500 may be disposed at a rear side of the dispenser 11.

The first refrigerating chamber door 10 may include an outer case 101 configured to form a front exterior. The first refrigerating chamber door 10 may further include a door liner 102 coupled to the outer case 101. The door liner 102 may open and close the refrigerating chamber 18.

In a state in which the outer case 101 is coupled to the door liner 102, an insulating space may be formed in a space between the outer case 101 and the door liner 102. An insulator may be provided in the insulating space.

The door liner 102 may include a first space 122 in which the first ice maker 200 is disposed. The first space 122 may also be referred to as a first ice making chamber. The door liner 102 may further include a second space 124 in which the second ice maker 500 is disposed. The second space 124 may also be referred to as a second ice making chamber.

In the present embodiment, the second ice maker 500 may be omitted, and in this case, the second space 124 may exist. In this case, the second space 124 may function as a door storage space used for a specific purpose. Alternatively, a position of the second ice maker 500 in the present embodiment may vary. Depending on the type of refrigerator, the second ice maker 500 may be positioned in the storage space. In this case, the second space 124 may be present or may be omitted.

The first space 122 may be formed as one side of the door liner 102 is recessed toward the outer case 101. The second space 124 may be formed as one side of the door liner 102 is recessed toward the outer case 101. For example, the second space 124 may be recessed toward the dispenser 11.

The first refrigerating chamber door 10 may include a first ice bin 280 in which ice generated in the first ice maker 200 is stored. The first refrigerating chamber door 10 may further include a second ice bin 600 in which ice generated in the second ice maker 500 is stored. Of course, if the second ice maker 500 is omitted, the second ice bin 600 may also be omitted.

The first ice bin 280 may be received in the first space 122 together with the first ice maker 200. The second ice bin 600 may be received in the second space 124 together with the second ice maker 500.

The first space 122 may be supplied with cold generated from a cooler. The cooler may be defined as a means for cooling the storage space, including at least one of a refrigerant cycle or a thermoelectric element. For example, cold air for cooling the freezing chamber 19 may be supplied to the first space 122. The second space 124 may be supplied with cold generated from a cooler. For example, cold air for cooling the freezing chamber 19 may be supplied to the second space 124.

The refrigerator 1 may include a supply passage 2a that guides cold air of the freezing chamber 19 or cold air of a space where an evaporator that generates cold air for cooling the freezing chamber 19 is disposed to the first refrigerating chamber door 10. The refrigerator 1 may include a discharge passage 2b that guides cold air discharged from the first refrigerating chamber door 10 to the freezing chamber 19 or the space where the evaporator is disposed. The supply passage 2a and the discharge passage 2b may be provided in the cabinet 2.

The first refrigerating chamber door 10 may include a cold air inlet 123a. When the first refrigerating chamber door 10 is closed, the cold air inlet 123a may be communicated with the supply passage 2a. The first refrigerating chamber door 10 may further include a cold air outlet 123b. When the first refrigerating chamber door 10 is closed, the cold air outlet 123b may be communicated with the discharge passage 2b.

The cold air inlet 123a may be formed on one side of the door liner 102. Although not limited, the one side of the door liner 102 may be a side facing a wall where the supply passage 2a is disposed in the refrigerating chamber 18 when the first refrigerating chamber door 10 is closed.

The cold air outlet 123b may be formed on one side of the door liner 102. Although not limited, the one side of the door liner 102 may be a side facing a wall where the discharge passage 2b is disposed in the refrigerating chamber 18 when the first refrigerating chamber door 10 is closed.

A shape of the ice generated from the first ice maker 200 may be the same as or different from a shape of the ice generated from the second ice maker 500. For example, the second ice maker 500 may form spherical ice. The “spherical shape” mentioned in this specification means not only a geometrically spherical shape but also a shape similar to a spherical shape.

A transparency of ice generated from the first ice maker 200 may be the same as or different from a transparency of ice generated from the second ice maker 500. For example, a transparency of the ice generated from the second ice maker 500 may be greater than a transparency of the ice formed from the first ice maker 200. A size (or volume) of ice generated from the first ice maker 200 may be different from a size (or volume) of ice generated from the second ice maker 500. For example, a size (or volume) of ice generated from the second ice maker 500 may be greater than a size (or volume) of ice formed from the first ice maker 200.

A structure of the first ice maker 200 for generating ice and a method for separation the generated ice may be the same as or different from a structure of the second ice maker 500 and a method for separation the ice generated from the second ice maker 500 is separated. If the structure and/or the method of the ice makers are different, a shape of the first space 122 where the first ice maker 200 is disposed may be different from a shape of the second space 124 where the second ice maker 500 is disposed.

For example, a depth of the second space 124 may be greater than a depth of the first space 122. Due to a difference in depth between the first space 122 and the second space 124, the one side of the door liner 102 may include a first side portion 102a and a second side portion 102b having different widths in a front-back direction. a width of the second side portion 102b may be formed to be greater than a width of the first side portion 102a. At least one of the cold air inlet 123a or the cold air outlet 123b may be formed on the second side portion 102b of the door liner 102. The second side portion 102b may protrude further toward the refrigerating chamber 18 than the first side portion 102a.

The first refrigerating chamber door 10 may further include a first door 130 (or a first space door) that opens and closes the first space 122. The first door 130 may be an insulated door having an insulator provided therein. The first refrigerating chamber door 10 may further include a second door 132 (or a second space door) that opens and closes the second space 124. The second door 132 may be an insulated door having an insulator provided therein. Even if the second ice maker 500 is omitted, the second door 132 may exist.

The first door 130 may be rotatably provided on the first refrigerating chamber door 10 by a hinge. The second door 132 may be rotatably provided on the first refrigerating chamber door 10 by a hinge. A rotation direction of the first door 130 and a rotation direction of the second door 132 may be the same or different.

Meanwhile, a basket 136 capable of storing food may be connected to the first door 130 by varying a thickness of the first refrigerating chamber door 10.

A filter (not shown) may be mounted at one side 103 of the first refrigerating chamber door 10, and the filter may be covered by a filter cover 142.

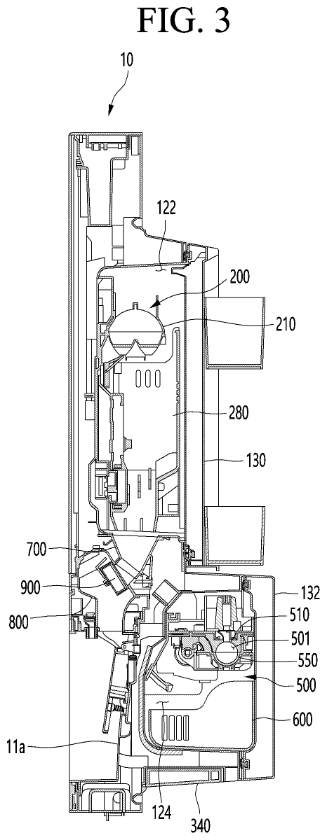

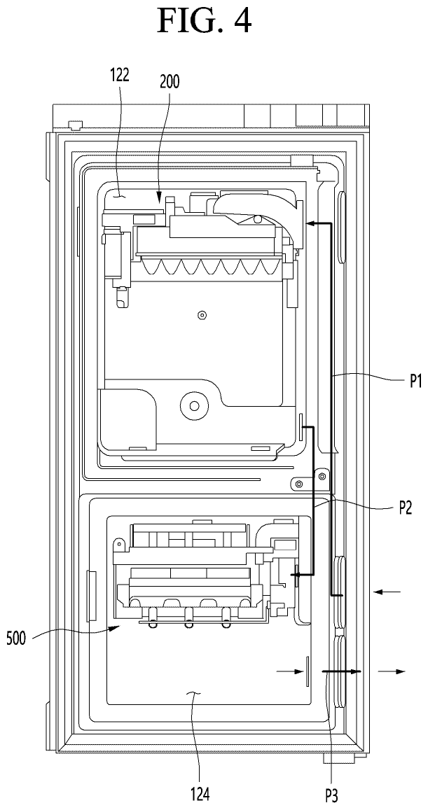

FIG. 3 is a cross-sectional view taken along line 3-3 of FIG. 1A. FIG. 4 is a drawing showing cold air passage in a first refrigerating chamber door of a first embodiment.

Referring to FIGS. 3 and 4, the first refrigerating chamber door 10 may further include a cold air passage for cold air flow. The cold air passage may be formed by a cold air duct, not shown. The cold air duct may be installed, for example, in the door liner 102.

The cold air passage may guide cold air to at least one of the first space 122 or the second space 124.

The cold air passage may include a first cold air passage P1. The first cold air passage P1 may guide cold air supplied from the cabinet 2 to the first space 122. Cold air guided by the first cold air passage P1 may flow toward the first ice maker 200.

The cold air passage may further include a second cold air passage P2. The second cold air passage P2 may guide cold air of the first space 122 to the second space 124. Cold air from a lower portion of the first space 122 may be discharged to the second cold air passage P2. Cold air may descend in the second cold air passage P2 and be supplied to the second space 124.

The cold air passage may further include a third cold air passage P3. The third cold air passage P3 may guide cold air of the second space 124 to an outside of the first refrigerating chamber door 10.

Meanwhile, the first ice maker 200 may include an ice tray 210 configured to form an ice making cell. The first ice maker 200 may further include a driver that provides power to automatically rotate the ice tray 210 to separate ice from the ice tray 210. The first ice maker 200 may further include a power transmission unit that transmits a power of the driver to the ice tray 210.

The ice tray 210 may include a plurality of ice making cells. Water discharged from a water supply portion and dropped onto the ice tray 210 may be distributed to the plurality of ice making cells.

When the ice generation in the ice tray 210 is completed, the ice may be separated from the ice tray 210 as the ice tray 210 is rotated (or twisted) by the driver. An ice separated from the ice tray 210 may be stored in the first ice bin 280.

The second ice maker 500 may include the first tray 510. The second ice maker 500 may further include a second tray 550. The first tray 510 and the second tray 550 may form an ice making cell 501. The second tray 550 may be moved with respect to the first tray 510. For example, the second tray 550 may be rotated with respect to the first tray 510, or may move linearly with respect to the first tray 510, or may move linearly and rotationally.

If the second tray 550 is a rotation type tray, water supply may be performed at a water supply position of the second tray 550. After the water supply is completed, the second tray 550 may be rotated to an ice making position. If the second tray 550 is a linear movement type tray, water supply may be performed at the ice making position of the second tray 550.

If the second tray 550 is a rotation type tray, at least a portion of the second tray 550 may be spaced apart from at least a portion of the first tray 510 at the water supply position. A portion of the second tray 550 spaced apart from the first tray 510 at the water supply position may come into contact with the first tray 510 at the ice making position to form the ice making cell 501.

The dispenser 11 may include a dispenser housing 11a. The dispenser housing 11a may form a receiving space. A container such as a cup may be positioned in the receiving space. Water or ice may be discharged into the receiving space. At least a portion of the dispenser housing 11a may be disposed to overlap the second space 124 in a front-back direction.

A minimum horizontal distance between a front surface of the first refrigerating chamber door 10 and the second space 124 is greater than a minimum horizontal distance between the front surface of the first refrigerating chamber door 10 and the first space 122 by the dispenser housing 11a.

A vertical length of the first space 122 may be greater than a vertical length of the second space 124. At least a portion of the second space 124 may overlap the first space 122 in the vertical direction. The ice making cell 501 of the second ice maker 500 may overlap the dispenser housing 11a in the front-back direction.

An ice chute 700 may be disposed at a lower side of the first space 122. The ice chute 700 may be opened and closed by a cap duct 900. An ice guide 800 may be disposed at a lower side of the ice chute 700. The ice chute 700 may guide ice discharged from the first ice bin 280 to the ice guide 800. The ice guide 800 may guide ice and finally discharge the ice. The ice chute 700 may overlap at least a portion of the first space 122 in a vertical direction. At least a portion of the ice chute 700 may overlap at least a portion of the second space 124 in the vertical direction. A water tank 340 may be detachably mounted on the first refrigerating chamber door 10. The ice guide 800 may overlap at least a portion of the second space 124 in a horizontal direction.

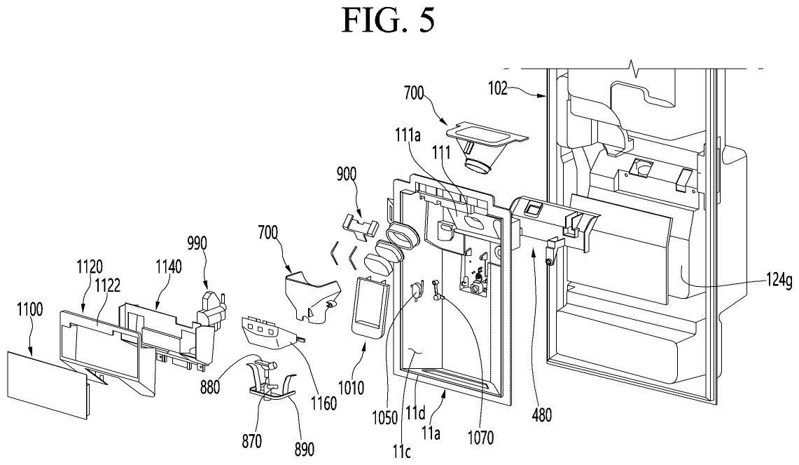

FIG. 5 is an exploded perspective view of a dispenser according to the present embodiment.

Referring to FIG. 5, a dispenser 11 of the present embodiment may include a dispenser housing 11a. The dispenser housing 11a may form a receiving space 11c. The receiving space 11c may be formed by a front surface of the dispenser housing 11a being recessed toward rearward.

The dispenser 11 may further include a pad 1010. The pad 1010 may also be referred to as an operation portion. The pad 1010 may be movably installed in the dispenser housing 11a. A user may manipulate the pad 1010 to discharge ice and/or water. For example, the user may push or press the pad 1010.

A lever 1070 that operates by the pad 1010 may be installed on the dispenser housing 11a. A switch 1050 that is selectively turned on or off by the lever 1070 may be installed on the dispenser housing 11a.

For example, when the pad 1010 is not operated, the switch 1050 may be turned off, and when the pad 1010 is operated, an operating force of the pad 1010 is transmitted to the lever 1070, so that the lever 1070 may turn on the switch 1050.

The dispenser housing 11a may further include an ice slot 111 through which ice guided by the ice chute 700 passes. The ice slot 111 may be formed, for example, in an inclined wall 111a of the dispenser housing 11a. The ice chute 700 may be disposed at an outer side of the dispenser housing 11a.

The ice guide 800 may be disposed in the receiving space 11c. The ice guide 800 may guide ice passed through the ice slot 111. The ice guide 800 may be disposed at a lower side of the inclined wall 111a.

The ice slot 111 may be opened and closed by the cap duct 900. The cap duct 900 may open and close the ice slot 111 in the receiving space 11c. The cap duct 900 may be driven by a duct driver 990 to open and close the ice slot 111. For example, the duct driver 990 may include a motor. The cap duct 900 may be rotated by a driving of the motor to open the ice slot 111.

The dispenser 11 may further include a water discharge port 870 through which water is discharged. The water discharge port 870 may be disposed in the receiving space 11c. The water discharge port 870 may be disposed adjacent to the ice guide 800.

The dispenser 11 may further include a supporter 890 that supports the water discharge port 870. The dispenser 11 may further include a sterilizing device 880 for sterilizing the water discharge port 870. The sterilizing device 880 may sterilize a water path formed by the water discharge port 870 by irradiating ultraviolet rays, for example.

The dispenser 11 may further include a display device. The display device may include a display 1100. The display 1100 may display an operating status of the refrigerator. The display 1100 may perform an input function that may receive a user's command. The user may select or change a temperature or various functions by manipulating or touching a button displayed on the display 1100.

The display device may further include a display frame 1120 that supports the display 1100. The display frame 1120 may be received in the receiving space 11c.

The display frame 1120 may include an opening 1122 in which at least a portion of the display 1100 is disposed. The display 1100 may be exposed to an outside through the opening 1122.

An input module 1160 may be installed in the display frame 1120. A type of ice may be selected through the input module 1160. Or, a state of the ice to be discharged may be selected through the input module 1160. For example, transparent ice or opaque ice may be selected through the input module 1160. Or, ices of different sizes may be distinguished and selected through the input module 1160.

The input module 1160 may include, for example, a button. A portion of the input module 1160 may be exposed to an outside while installed in the display frame 1120.

It is also possible for the input module 1160 to be installed or supported in a configuration other than the display frame 1120. Of course, it is also possible for the display 1100 to additionally perform a function of the input module without a separate input module 1160.

The display device may further include a display supporter 1140 disposed at a rear side of the display frame 1120. The display supporter 1140 may support the display 1100 penetrating the opening 1122. Of course, the display supporter 1140 may be omitted.

Meanwhile, the dispenser housing 11a may be coupled to the door liner 102. The door liner 102 may include a space forming wall 124g forming the second space 124. The dispenser housing 11a may be disposed in front of the space forming wall 124g. A mounting bracket 480 for guiding water to the second space 124 may be installed in the space forming wall 124g. The mounting bracket 480 may be disposed at a rear of the ice guide 800. That is, the mounting bracket 480 may be disposed to overlap the ice guide 800 in a front-back direction.

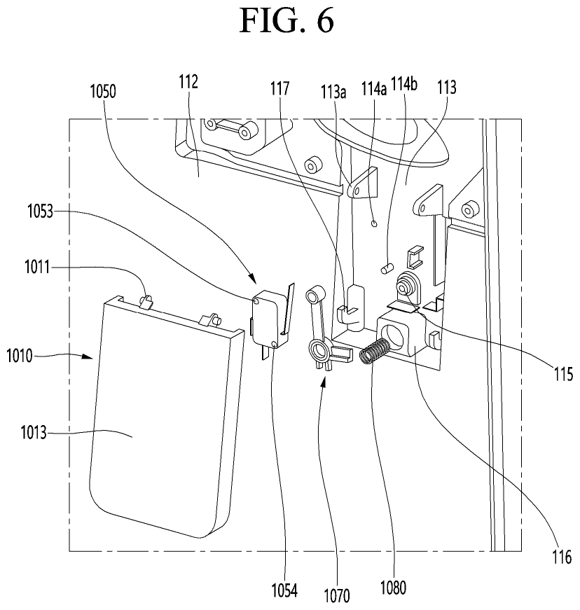

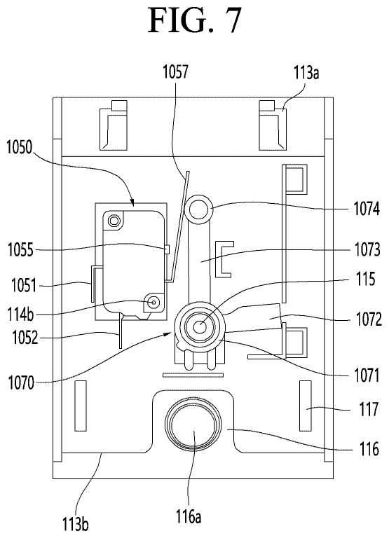

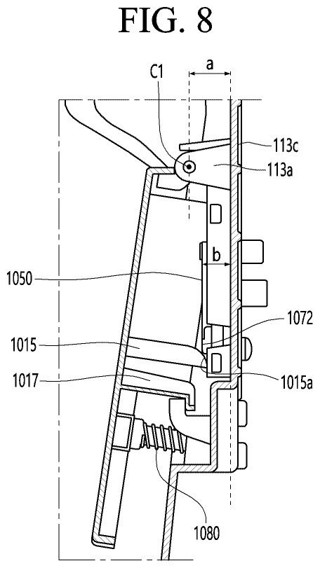

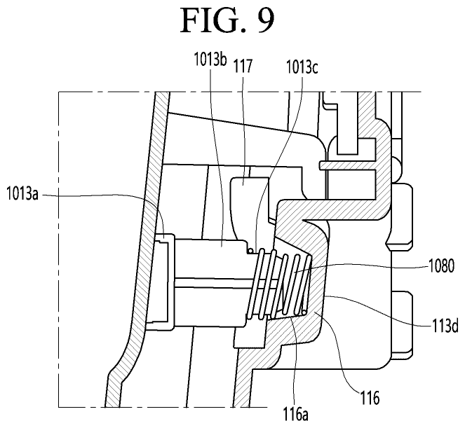

FIG. 6 is a drawing showing a state in which a pad, a switch, and a lever are separated in a dispenser according to a first embodiment. FIG. 7 is a drawing showing a receiving portion according to a first embodiment. FIG. 8 is a vertical cross-sectional view showing a state in which a pad is installed in a dispenser according to a first embodiment. FIG. 9 is a cross-sectional view showing a structure of a first supporter according to a first embodiment.

FIG. 8 shows a state in which a pad is not manipulated, and FIG. 9 shows a state in which a pad is manipulated.

Referring to FIGS. 5 to 9, the dispenser housing 11a may include a rear wall 112 configured to form the receiving space 11c. The rear wall 112 may include a receiving portion 113 having a recessed shape. The receiving portion 113 may receive the switch 1050. The switch 1050 may be referred to as a signal generating component.

The receiving portion 113 may be recessed in the rear wall 112 away from an opening 11d of the dispenser housing 11a. That is, the receiving portion 113 may be recessed in the rear wall 112 toward the second space 124.

The receiving portion 113 may receive a portion of the pad 1010. A left-right width of the receiving portion 113 may be equal to or greater than a left-right width of the pad 1010. The receiving portion 113 may be provided with a hinge supporter 113a that rotatably supports the pad 1010. For example, a pair of hinge supporters 113a may be disposed to be spaced apart from each other in a horizontal direction. The hinge supporter 113a may protrude from the receiving portion 113 toward an opening 11d of the dispenser housing 11a.

The pad 1010 may include a pad body 1013. A front surface of the pad body 1013 may face an opening 11d of the dispenser housing 11a. A rear surface of the pad body 1013 may face the receiving portion 113.

The pad 1010 may further include a hinge 1011 rotatably connected to the hinge supporter 113a. The hinge 1011 may be disposed at an upper side of the pad body 1013. Accordingly, a central portion and a lower portion of the pad 1010 may pivot around the hinge 1011.

The switch 1050 may be installed at a lower side of the hinge supporter 113a in the receiving portion 113. A coupling hole 114a or a coupling groove may be formed in the receiving portion 113 to which a coupling member passing the switch 1050 is coupled. The switch 1050 may include a through hole 1053 through which the coupling member penetrating. A coupling protrusion 1114b for insertion into the switch 1050 may be formed at a position spaced apart from the coupling hole 114a. The switch 1050 may include a protrusion hole 1054 (or a protrusion groove) for inserting the coupling protrusion 114b.

The switch 1050 may further include a plurality of terminals 1051, 1052 for electrical connection. The switch 1050 may further include a switch extension 1057. The switch extension 1057 may be installed on the switch 1050 to be elastically deformable. The switch extension 1057 may be selectively pressed by the lever 1070.

The switch 1050 may further include a pin 1055 that is selectively pressed by the switch extension 1057. For example, when the pin 1055 is pressed, the switch 1050 may be turned on.

The receiving portion 113 may further include a lever shaft 115 that rotatably supports the lever 1070. The lever shaft 115 may protrude from the receiving portion 113 toward an opening 11d of the dispenser housing 11a.

In a state in which the switch 1050 is installed in the receiving portion 113, the lever shaft 115 may be disposed lower than the switch extension 1057. In a state in which the switch 1050 is installed in the receiving portion 113, at least a portion of the lever shaft 115 may be disposed lower than the switch 1050 the switch 1050 (excluding terminal).

The lever 1070 may include a lever body 1071 coupled to the lever shaft 115. The lever body 1071 may be formed in a cylindrical shape, for example. The lever shaft 115 may be inserted into the lever body 1071.

The lever 1070 may include a first extension 1072 extending from a point of the lever body 1071. The first extension 1072 may, for example, extend radially from the lever body 1071. The first extension 1072 may be selectively pressed by the pad 1010.

The lever 1070 may further include a second extension 1073 extending from another point of the lever body 1071. The second extension 1073 may, for example, extend radially from the lever body 1071. The first extension 1072 and the second extension 1073 may be disposed to form a predetermined angle with respect to the lever body 1071. The second extension 1073 serves to transmit a rotational power of the lever 1070. A length of the second extension 1073 may be different from a length of the first extension 1072. For example, the length of the second extension 1073 may be greater than the length of the first extension 1072.

The lever 1070 may further include a pressing portion 1074 formed at an end of the second extension 1073. During a rotation of the lever 1070, the pressing portion 1074 may press the switch extension 1057. For example, the pressing portion 1074 may be formed in a cylindrical shape. A diameter or left-right width of the pressing portion 1074 may be greater than a left-right width of the second extension 1073. When the pad 1010 is not operated, the pressing portion 1074 may come into contact with the switch extension 1057.

The dispenser 11 may further include an elastic member 1080 that elastically supports the pad 1010. The elastic member 1080 may be, for example, a coil spring.

The receiving portion 113 may further include a first supporter 116 for supporting the elastic member 1080. The first supporter 116 may be disposed at a lower side of the lever shaft 115 in the receiving portion 113. The first supporter 116 may be provided with a seating groove 116a into which a portion of the elastic member 1080 is inserted.

The pad 1010 may further include a lever operating portion 1015 protruding from a rear side of the pad body 1013. When the pad 1010 is not operated, the lever operating portion 1015 may be disposed at a lower side of the second extension 1073. An inclined surface 1015a may be provided at an end of the lever operating portion 1015. In a process of the pad 1010 being pressed and rotated, the first extension 1072 may rise by the inclined surface 1015a. When the first extension 1072 rises, the lever 1070 may be rotated.

The pad 1010 may further include a second supporter supporting the elastic member 1080. The second supporter may protrude from a rear surface of the pad body 1013. The second supporter may be disposed at a lower side of the lever operating portion 1015 at a rear surface of the pad 1010.

The second supporter may include a first part 1013a extending from the rear surface of the pad body 1013. The second supporter may further include a second part 1013b extending from the first part 1013a. The second supporter may further include a third part 1013c extending from the second part 1013b. A diameter of the second part 1013b may be greater than a diameter of the third part 1013c.

The third part 1013c may be received in a space defined by the elastic member 1080. The elastic member 1080 may be seated on the second part 1013b. That is, one end of the elastic member 1080 may be supported on a seating groove 116a of the first supporter 116, and another end of the elastic member 1080 may be supported on the second part 1013b.

In a non-operated state of the pad 1010, the second supporter may be disposed outside the seating groove 116a. In an operated state of the pad 1010, a portion of the second supporter may be received in the seating groove 116a. For example, the third part 1013b may be receive d in the seating groove 116a. In another aspect, the first part 1013a may be omitted.

The pad 1010 may further include a stopper 1017 protruding from a rear surface of the pad body 1013. For example, a plurality of stoppers 1017 may be disposed to be spaced apart from each other in a horizontal direction in the pad body 1013. The receiving portion 113 may be provided with a stopper engaging portion 117 to engage the stopper 1017. For example, a plurality of stopper engaging portions 117 may be disposed to be spaced apart from each other in a horizontal direction. The first supporter 116 may be disposed between the plurality of stopper engaging portions 117.

Referring to FIG. 8, the receiving portion 113 may include a first wall 113c on which the switch 1050 is mounted. The hinge supporter 113a may protrude from the first wall 113c. Accordingly, the lever 1070 may be mounted on the first wall 113c.

In a state in which a hinge 1011 of the pad 1010 is coupled to the hinge supporter 113a, a horizontal distance a from the first wall 113c to a center C1 of the hinge 1011 may be greater than a horizontal distance b from the first wall 113c to the switch 1050. At this time, the horizontal distance b from the first wall 113c to the switch 1050 means a distance from the first wall 113c to a surface of the switch 1050 facing the pad 1010.

The receiving portion 113 may further include a second wall 113d that is stepped from the first wall 113c. The second wall 113d may be disposed closer to an opening 11d of the dispenser housing 11a than the first wall 113c. The first supporter 116 may be provided on the second wall 113d.

According to the present embodiment, since the lever 1050 rotates around a lever shaft 115, a rotation center of the lever 1050 may be extended in a horizontal direction. Therefore, there is an advantage in that a depth of a space (e.g., a receiving portion) required for the lever 1050, may be reduced.

By reducing a depth of the space (e.g., the receiving portion) required for the lever 1050 to rotate, a width in a front-back direction of the dispenser housing 11a can be reduced. That is, the dispenser housing 11a may be slimmed down. In this case, it is possible to form the second space 124 at a rear side of the dispenser housing 11a.

If the hinge 1011 is disposed on an upper side of the pad 1010, and a distance from the first wall 113c where the hinge supporter 113a is formed to a center C1 of the hinge 1011 is greater than a distance b from the first wall 113c to the switch 1050, there is an advantage in that a depth of a space (e.g., the receiving portion) required for a rotation of the pad 1010, may be reduced.

Since the hinge 1011 is disposed at an upper side of the pad 1010, the pad may be operated by pressing a portion of the pad 1010 that is lower than the hinge 1011, so there is an advantage in that the user can easily operate the pad 1010.

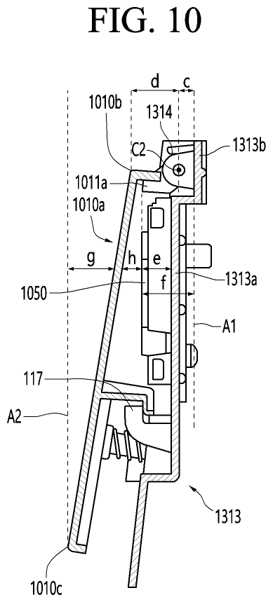

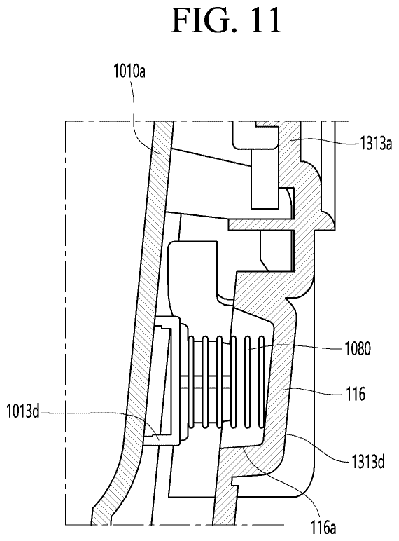

FIG. 10 is a vertical cross-sectional view showing a state in which a pad is installed in a dispenser according to a second embodiment. FIG. 11 is a cross-sectional view showing a structure of a first supporter according to a second embodiment.

FIG. 10 shows a modified example of FIG. 8, and FIG. 11 shows a modified example of FIG. 9.

This embodiment is identical to the previous embodiment in other parts, but differs in a shape of the receiving portion. Therefore, only the characteristic parts of this embodiment will be described below.

Referring to FIGS. 10 and 11, the receiving portion 1313 of the present embodiment may include a first wall 1313a on which a switch 1050 is mounted. The lever 1070 may be mounted on the first wall 1313a. The receiving portion 1313 may further include a second wall 1313b that is stepped from the first wall 1313a. The second wall 1313b may be disposed at an upper side of the first wall 1313a. The first wall 1313a may be disposed closer to an opening 11d of the dispenser housing 11a than the second wall 1313b.

A hinge supporter 1314 may be provided on the second wall 1313b to rotatably support a hinge 1011a of the pad 1010a.

In a non-operated state of the pad 1010a, a horizontal distance c from the second wall 1313b to a rotation center C2 of the hinge 1011a may be equal to or less than a horizontal distance d from a rotation center C2 to a front uppermost portion 1010b of the pad 1010a.

A line extending vertically from a front surface of the second wall 1313b may be referred to as a first virtual line A1. In a non-operated state of the pad 1010a, a horizontal distance f from the first virtual line A1 to the switch 1050 may be equal to or greater than a horizontal distance b from the second wall 1313b to a rotation center C2 of the hinge 1011a.

In a non-operated state of the pad 1010a, a distance h from the switch 1050 to a rear surface of the pad 1010a may be less than a distance e from the first wall 1313a to a surface of the switch 1050 facing the pad 1010a.

In a non-operated state of the pad 1010a, a line extending vertically from a front lowermost end 1010c of the pad 1010a may be referred to as a second virtual line A2. A distance g from the second virtual line A2 to a point on a front surface of the pad 1010a may be greater than a distance h from the switch 1050 to a point on a rear surface of the pad 1010a. At this time, the point on the front surface may be a point facing the switch 1050. The point on the rear surface of the pad 1010a may be a point disposed at the same height as the point on the front surface.

The receiving portion 1313 may further include a third wall 1313d that is stepped from the first wall 1313a. The third wall 1313d may be disposed at a lower side of the first wall 1313a.

The third wall 1313d may be disposed loser to an opening 11d of the dispenser housing 11a than the first wall 1313a. The first supporter 116 may be provided on the third wall 1313d. A size of a step between the first wall 1313a and the second wall 1313b may be greater than a size of a step between the first wall 1313a and the third wall 1313c.

A rear surface of the pad 1010a may be provided with a second supporter 1013d on which an elastic member 1080 is supported. In a non-operated state of the pad 1010a, the second supporter 1013d may be disposed outside a seating groove 116a of the support member 116. In an operated state of the pad 1010a, a portion of the second supporter 1013d may be received in the seating groove 116a of the support member 116.

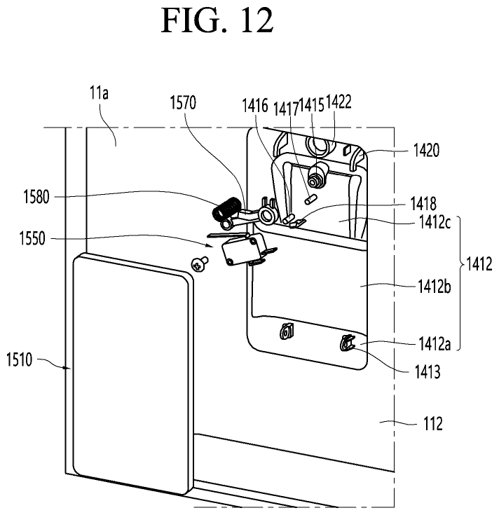

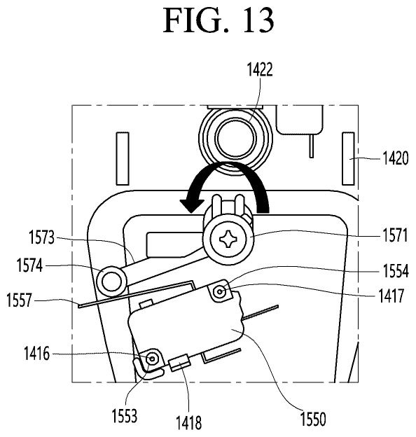

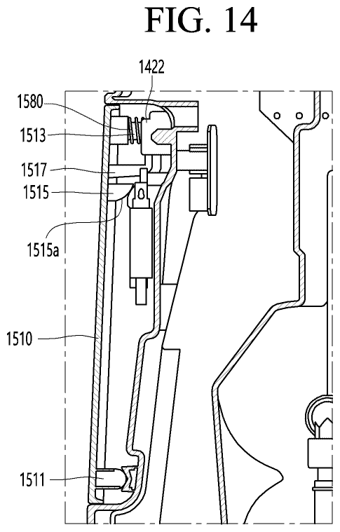

FIG. 12 is a drawing showing a state in which a pad, a switch, and a lever are separated in a dispenser according to a third embodiment. FIG. 13 is a drawing showing a state in which a switch and a lever are installed in a receiving portion according to a third embodiment. FIG. 14 is a vertical cross-sectional view showing a state in which a pad is installed in a dispenser according to a third embodiment.

FIG. 12 shows a modified example of FIG. 6.

In the following, only the characteristic parts of the present embodiment will be described, and the same configurations as the previous embodiment will be used with the same drawing reference numerals and detailed descriptions will be omitted.

Referring to FIGS. 12 to 14, a dispenser 11 of the present embodiment may include a dispenser housing 11a and a pad 1510 installed in the dispenser housing 11.

The dispenser housing 11a may include a rear wall 112. The rear wall 112 may include a receiving portion 1412 having a recessed shape.

The receiving portion 1412 may receive a switch 1550. The receiving portion 1412 may receive the pad 1510.

The receiving portion 1412 may include a first portion 1412a. The first portion 1412a may be provided with a hinge supporter 1413. A hinge 1511 rotatably supported by the hinge supporter 1413 may be provided on a lower rear surface of the pad 1510.

The receiving portion 1412 may further include a second portion 1412b disposed at an upper side of the first portion 1412a. A recessed depth of the second portion 1412b may be different from a recessed depth of the first portion 1412a.

At least a portion of the second portion 1412b may be positioned closer to an opening 11d of the dispenser housing 11c (see FIG. 5) than the first portion 1412a. An amount of foam liquid that can be filled into the first refrigerating chamber door 10 may be increased by the second portion 1412b, thereby improving an insulation performance.

The receiving portion 1412 may further include a third portion 1412c disposed at an upper side of the second portion 1412b. At least a portion of the second portion 1412b may be positioned closer to an opening 11d of the dispenser housing 11c (see FIG. 5) than the third portion 1412c.

A switch 1550 and a lever 1570 may be installed in the third portion 1412c. The third portion 1412c may be provided with a plurality of coupling protrusions 1416, 1417 for insertion into the switch 1550. The switch 1550 may be provided with a plurality of protrusion holes 1553, 1554 for insertion of the plurality of coupling protrusions 1416, 1417, respectively. A rotation of the switch 1550 may be restricted by the plurality of coupling protrusions 1416, 1417.

The third portion 1412c may further include a hook 1418 that is caught on the switch 1550 in a state in which the plurality of coupling protrusions 1416, 1417 are inserted into the plurality of protrusion holes 1553, 1554. The hook 1418 can be caught on a surface of the switch 1550 to prevent separation of the switch 1550. That is, the switch 1550 may be installed in the receiving portion 1412 without using a separate coupling member. Accordingly, there is an advantage in that a space for coupling the coupling member to the receiving portion 1412 is unnecessary, and accordingly, slimming of the dispenser housing 11a is possible.

The third portion 1412c may be provided with a lever shaft 1415 that rotatably supports the lever 1570. The lever shaft 1415 may be disposed higher than the switch 1550.

The lever 1570 may include a lever body 1571 rotatably connected to the lever shaft 1415. The lever 1570 may further include an extension 1573 that extends radially from the lever body 1571.

The switch 1550 may include a switch extension 1557. A pressing portion 1574 for pressing the switch extension 1557 may be provided at an end of the extension 1573. The pressing portion 1574 may be formed in a cylindrical shape, for example. A diameter or a left-right width of the pressing portion 1574 may be greater than a left-right width of the extension 1573.

The pad 1510 may further include a lever operating portion 1515 protruding from a rear surface of the pad 150. The lever operating portion 1515 may be disposed at an upper side of the hinge 1511 in a rear surface of the pad 1510.

When the pad 1510 is not operated, the lever operating portion 1515 may be disposed at an upper side of the extension 1573. An inclined surface 1515a may be provided at an end of the lever operating portion 1515. In a process of the pad 1510 being pressed and rotated, the extension 1573 may be lowered by the inclined surface 1515a. When the extension 1573 is lowered, the lever 1570 may be rotated counterclockwise with respect to FIG. 13.

The third portion 1412c may be provided with a first supporter 1422 that supports an elastic member 1580 that elastically supports the pad 1510. The first supporter 1422 may be disposed at an upper side of the lever shaft 1415.

The pad 1510 may further include a second supporter 1513 that protrudes from a rear surface thereof and supports the elastic member 1580. In a state in which the elastic member 1580 is supported by the second supporter 1513, a portion of the second supporter 1513 may be disposed within an area defined by the elastic member 1580. The second supporter 1513 may be disposed at an upper side of the lever operating portion 1515 at a rear surface of the pad 1510.

The pad 1510 may further include a stopper 1517 that protrudes from a rear surface thereof. For example, a plurality of stoppers 1517 may be disposed to be spaced apart from each other in a horizontal direction on the pad 1550.

The third portion 1412c may be provided with a stopper engaging portion 1420 for engaging the stopper 1517. For example, a plurality of stopper engaging portions 1420 may be disposed to be spaced apart from each other in a horizontal direction. The first supporter 1442 may be positioned between the plurality of stopper engaging portions 1420.

1. A refrigerator comprising:
a cabinet forming a storage space;
a door configured to open and close the storage space;
an ice maker provided in the cabinet or door and configured to generate ice; and
a dispenser provided on the door and configured to discharge the ice generated by the ice maker,
wherein the dispenser includes:
a dispenser housing,
a receiving portion having a recessed shape and provided in the dispenser housing,
an operation portion movably installed in the dispenser housing,
a switch installed in the receiving portion,
a lever configured to transmit an operating force of the operation portion to the switch,
wherein the operation portion includes a hinge,
a lever operating portion configured to operate the lever and disposed at a lower side of the hinge.

2. The refrigerator of claim 1,
wherein the receiving portion includes a hinge supporter that rotatably supports the hinge, and
the switch is disposed at a lower side of the hinge supporter.

3. The refrigerator of claim 2,
wherein the dispenser further includes an elastic member that elastically supports the operation portion, and
wherein the receiving portion further includes a first supporter that supports the elastic member.

4. The refrigerator of claim 3,
wherein the receiving portion includes a first wall on which the switch is installed, and
a second wall that is stepped from the first wall,
wherein the hinge supporter is provided on the first wall and the first supporter is provided on the second wall.

5. The refrigerator of claim 4,
wherein a horizontal distance from the first wall to a center of the hinge is greater than a horizontal distance from the first wall to a surface of the switch facing the operation portion.

6. The refrigerator of claim 4,
wherein the second wall is disposed closer to an opening of the dispenser housing than the first wall.

7. The refrigerator of claim 3,
wherein the operation portion further includes a second supporter that supports the elastic member and is disposed lower than the lever operating portion.

8. The refrigerator of claim 7,
wherein the first supporter includes a seating groove on which the elastic member is seated, wherein in a non-operated state of the operation portion, the second supporter is disposed outside the seating groove, and
in an operated state of the operation portion, a portion of the second supporter is received within the seating groove.

9. The refrigerator of claim 4,
wherein the receiving portion includes a first wall in which the switch is installed, and a second wall that is stepped from the first wall and in which the hinge supporter is formed,
wherein the first wall is disposed closer to an opening of the dispenser housing than the second wall.

10. The refrigerator of claim 9,
wherein in a non-operated state of the operation portion, a horizontal distance from the second wall to a rotation center of the hinge is equal to or less than a horizontal distance from the rotation center of a front uppermost portion of the operation portion.

11. The refrigerator of claim 9,
wherein in a non-operated state of the operation portion, a distance from the switch to a rear surface of the operation portion is less than a distance from the first wall to a surface of the switch, and
the surface of the switch faces the operation portion.

12. The refrigerator of claim 9,
wherein a distance from a vertical line extending vertically from a front bottom end of the operation portion to a point on a front surface of the operation portion is equal to or greater than a distance from the switch to a point on a rear surface of the operation portion,
wherein the point on the front surface is a point facing the switch, and the point on the rear surface is a point disposed at the same height as the point on the front surface.

13. The refrigerator of claim 9,
wherein the receiving portion further include a third wall that is stepped from the first wall and in which the first supporter is formed, and
the third wall is disposed closer to an opening of the dispenser housing than the first wall.

14. The refrigerator of claim 13,
wherein a size of a step difference between the first wall and the second wall is greater than a size of a step difference between the first wall and the third wall.

15. The refrigerator of claim 1,
wherein the receiving portion further includes a lever shaft rotatably supporting the lever, wherein the lever includes,
a lever body coupled to the lever shaft,
a first extension extending from one point of the lever body and pressed by the operation portion,
a second extension extending from another point of the lever body and configured to transmit a rotational force of the lever to the switch.

16. A refrigerator comprising:
a cabinet forming a storage space;
a door configured to open and close the storage space;
an ice maker provided in the cabinet or door and configured to generate ice; and
a dispenser provided on the door and configured to discharge the ice generated by the ice maker,
wherein the dispenser includes:
a dispenser housing,
a receiving portion having a recessed shape and provided in the dispenser housing,
an operation portion movably installed in the dispenser housing,
a switch installed in the receiving portion,
a lever configured to transmit an operating force of the operation portion to the switch,
wherein the operation portion includes a hinge,
a lever operating portion configured to operate the lever and disposed at an upper side of the hinge, and
a supporter disposed higher than the lever operating portion and configured to support the elastic member.

17. The refrigerator of claim 16,
wherein the receiving portion includes a plurality of coupling protrusions for coupling with the switch, and a hook that is caught on the switch in a state in which the plurality of coupling protrusions are inserted into the switch.

18. The refrigerator of claim 16,
wherein the receiving portion includes a first portion in which the hinge is installed,
a second portion disposed at an upper side of the first portion and having a different recessed depth from the first portion, and
a third portion disposed at an upper side of the second portion and in which the switch is installed.

19. The refrigerator of claim 18,
wherein at least a portion of the second portion is disposed closer to an opening of the dispenser housing than the first portion and the third portion.
